(19) United States
(12) Patent Application Publication
(10) Pub. No.: US 2022/0080432 A1
(43) Pub. Date: Mar. 17, 2022

(54) SHOWER APPARATUS

(71) Applicant: Purity (Xiamen) Sanitary Ware Co., Ltd., Xiamen City (CN)

(72) Inventors: JAMES WU, Taichung City (TW); ALEX WU, Taichung City (TW); CE-WEN YANG, Xiamen City (CN); CHING-YIN WU, Taichung City (TW); CHE-MIN LIN, Taichung City (TW)

(73) Assignee: Purity (Xiamen) Sanitary Ware Co., Ltd., Xiamen City (CN)

(21) Appl. No.: 16/952,927

(22) Filed: Nov. 19, 2020

(30) Foreign Application Priority Data
Sep. 17, 2020 (CN) 202022047046.2

(51) Int. Cl. B05B 1/18; B05B 15/62

(52) U.S. Cl. CPC B05B 1/185; B05B 15/62

(57) ABSTRACT

A showering appliance includes a handheld showerhead and a fixed shower head which includes a fixed portion, a first outlet portion, a first peripheral portion, and a first connector. The fixed portion has a first inlet channel communicating with the first outlet portion. The first peripheral portion is located around the first outlet portion and is disposed with the first connector. The handheld showerhead includes a handle, a second outlet portion, a second peripheral portion, and a second connector. The handle has a second inlet channel communicating with the second outlet portion. The second peripheral portion is located around the second outlet portion and is disposed with the second connector. The first connector and the second connector are magnetically attracted to each other, so that the handheld shower head could be magnetically attached to the first peripheral portion of the fixed shower head, thereby fixing the handheld showerhead.

### BACKGROUND OF THE INVENTION

### Technical Field

The present invention relates generally to a bathroom fixture, and more particularly to a shower apparatus.

### Description of Related Art

A conventional shower fixture includes a top showerhead and a handheld shower, wherein the top showerhead is fixed on a top portion of a wall surface, and a fixing seat for holding the handheld shower is disposed on the wall surface. A position where the fixing seat is located at is lower than a position where the top showerhead is located at, so that a user could easily take the handheld shower held on the fixing seat to use. After showering, the user could put the handheld shower back to the fixing seat.

However, an engaging way of engaging the handheld shower with the fixing seat is not convenient, so that it is not easy for the user to take or put back the handheld shower. Additionally, if the user needs to broaden a spray area of the top showerhead, the conventional shower fixture could not satisfy the user's need.

In order to solve the aforementioned problems, there is a showering appliance 1 been developed as shown in FIG. 1, wherein a handheld shower head 2 is engaged with a groove 3 of a fixed shower head 4 by plugging. However, the handheld showerhead 2 could only be mounted at a single place without another choice. Besides, when only the fixed shower head 4 outputs water, a center of the fixed shower head 4 is unable to output water, thereby losing a certain spray area. Therefore, the conventional showering appliance has room for improvement.

### BRIEF SUMMARY OF THE INVENTION

In view of the above, the primary objective of the present invention is to provide a showering appliance, wherein a handheld showerhead of the showering appliance is able to be attached to the fixed shower head.

In addition, the another primary objective of the present invention is to provide a showering appliance to form multiple output spray patterns.

The inventive subject matter provides a showering appliance includes a fixed shower head and a handheld showerhead. The fixed shower head includes a fixed portion, a first outlet portion, a first peripheral portion, and a plurality of first connectors. The fixed portion has a first inlet channel which communicates with the first outlet portion. The first peripheral portion is located around the first outlet portion and has a plurality of first side portions. The plurality of first connectors are respectively disposed at the plurality of first side portions. The handheld showerhead includes a handle, a second outlet portion, a second peripheral portion, and a plurality of second connectors. The handle has a second inlet channel which communicates with the second outlet portion; the second peripheral portion is located around the second outlet portion and has a plurality of second side portions; the plurality of second connectors are respectively disposed at the plurality of second side portions. One of the plurality of first connectors and one of the plurality of second connectors are magnetically attracted to each other, so that one of the plurality of second side portions of the second peripheral portion of the handheld showerhead is able to be magnetically attached to one of the plurality of first side portions of the first peripheral portion of the fixed shower head.

The handheld showerhead has a first axis and a second axis which is perpendicular to the first axis; each of two opposite sides of the second peripheral portion along the first axis has one of the second side portions.

A number of the plurality of first side portions of the first peripheral portion is four.

Each of the plurality of first connectors comprises a plurality of magnetic members which are disposed at one of the plurality of first side portions and are arranged along a peripheral direction of the fixed shower head. Each of the plurality of second connectors comprises a plurality of magnetizable members, each of the plurality of magnetizable members is a magnet or a magnetizable material. The plurality of magnetizable members of each of the plurality of second connectors are disposed at one of the plurality of second side portions and are arranged along the second axis of the handheld showerhead. Each of the plurality of magnetic members of one of the plurality of first connectors of the fixed shower head is magnetically attracted to each of the plurality of magnetizable members of one of the plurality of second connectors of the handheld showerhead.

When one of the plurality of second side portions of the second peripheral portion is magnetically attached to one of the plurality of first side portions of the first peripheral portion, the handle does not contact with the first side portions

Each of the plurality of second side portions has a groove, and each of the plurality of second connectors is disposed of in the groove of one of the plurality of second side portions. A side cover is disposed on each of the grooves to seal an opening of each of the grooves.

Each of the grooves comprises a groove section and at least one recess, and each of the groove sections has a groove surface which is recessed to form the at least one recess. Each of the plurality of second connectors is disposed in the at least one recess of one of the grooves; each of the side covers is engaged with one of the groove sections. Each of the side covers has an inner surface which is recessed to form at least one recess. A part of the second connectors protrudes into the at least one recess of the side covers.

A number of the at least one recess of each of the grooves is plural. The plurality of the recess of each of the grooves is arranged along the second axis of the handheld showerhead. Each of the plurality of second connectors comprises a plurality of magnetizable members which are respectively disposed in the plurality of recess of each of the grooves.

The handheld shower head includes a first section and a second section; the first section has the handle, and the second section includes a front shell and a rear cover. The front shell is connected to the first section and has two side walls which are opposite along the first axis of the handheld shower head. A front side of the front shell has the second outlet portion. A rear side of the front shell has a rear opening which is opposite to the second outlet portion. The rear cover comprises a cover body and a protruding periphery. The protruding periphery has two side portions which are opposite along the first axis of the handheld shower head. The plurality of second connectors are respectively disposed at the two side portions of the protruding periphery. The cover body seals the rear opening, and the two side portions of the rear cover are respectively located between the two side walls of the front shell. Each of the side walls of the front shell and corresponding one of the side portions the back cover constitute one of the plurality of second side portions.

An inner wall of each of the side walls is recessed to form at least one recess, and a part of each of the plurality second connectors protrudes into the at least one recess on the inner wall of one of the side walls.

With the aforementioned design, the handheld showerhead could be magnetically attached to the fixed showerhead, and the handheld showerhead is able to be quickly attached or detached from the fixed shower head. Additionally, the fixed shower head is selectively attached to different first side portions of the fixed shower head to form various output patterns.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the conventional shower apparatus;

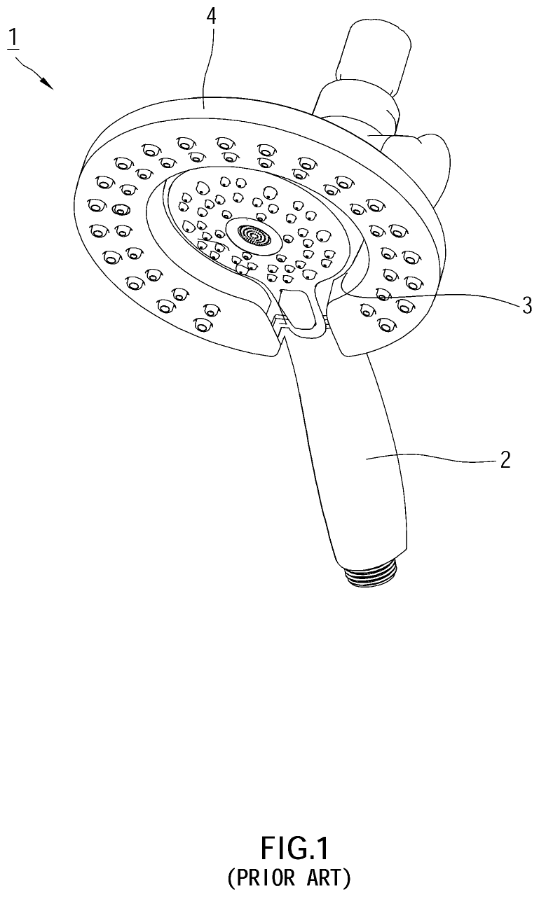

FIG. 2 is a perspective view of the showering appliance of a first embodiment according to the present invention:

FIG. 3 is a perspective view of the fixed shower head of the first embodiment according to the present invention:

FIG. 4 is a perspective view of the fixed shower head of the first embodiment according to the present invention seen from another perspective:

FIG. 5 is a perspective view of the handheld showerhead of the first embodiment according to the present invention;

FIG. 6 is an exploded view of the handheld showerhead of the first embodiment according to the present invention:

FIG. 7 is a schematic view, showing the handheld showerhead is magnetically attached to the fixed shower head at different positions:

FIG. 8 is a perspective view of the handheld showerhead of a second embodiment according to the present invention:

FIG. 9 is an exploded view of the handheld showerhead of the second embodiment according to the present invention:

FIG. 10 is a perspective view of the handheld showerhead of a third embodiment according to the present invention:

FIG. 11 is an exploded view of the handheld showerhead of the third embodiment according to the present invention; and

FIG. 12 is an exploded view of the handheld showerhead of the third embodiment according to the present invention seen from another perspective.

### DETAILED DESCRIPTION OF THE INVENTION

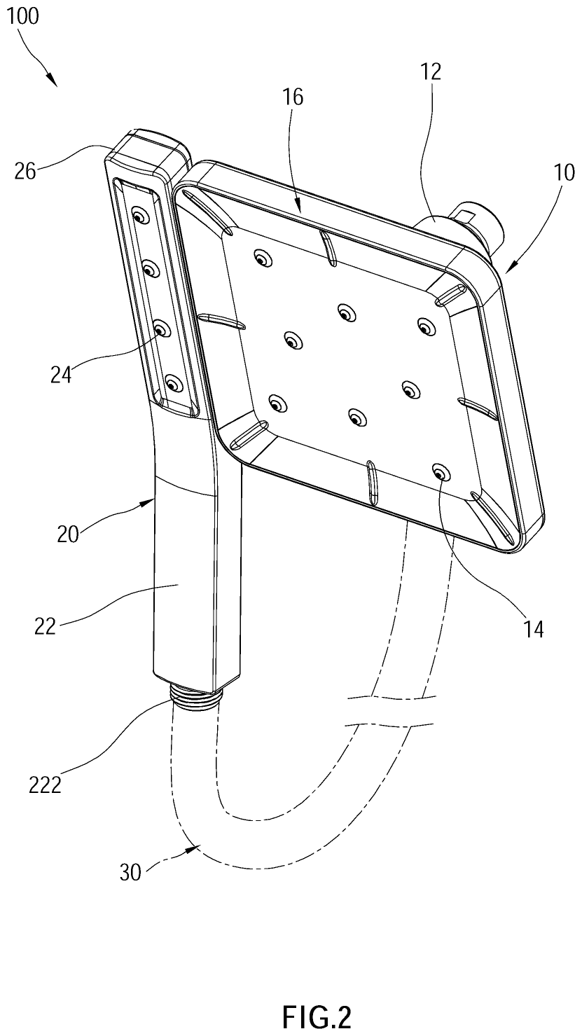

As illustrated in FIG. 2, a showering appliance 100 includes a fixed shower head 10 and a handheld showerhead 20.

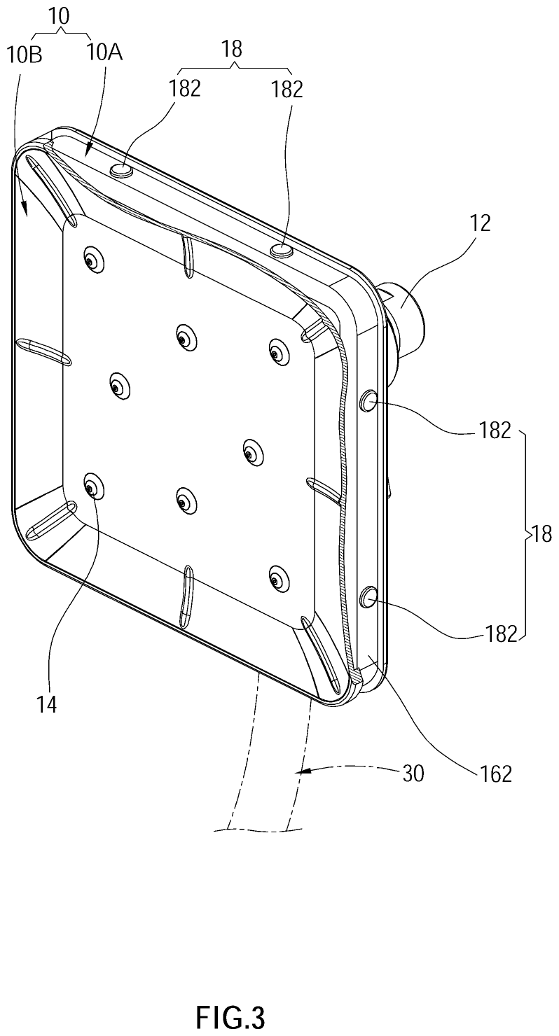

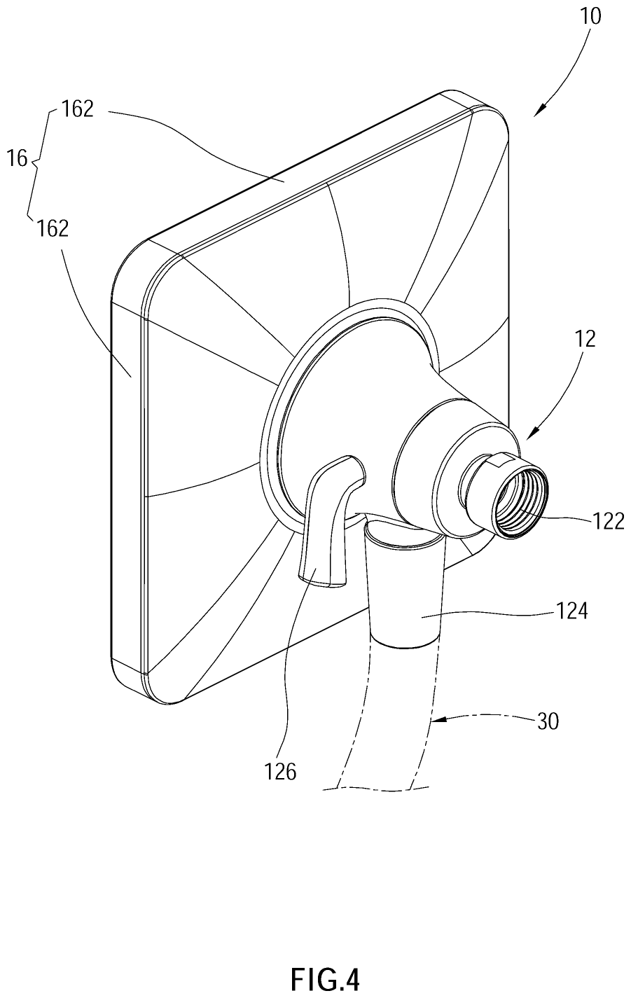

As illustrated in FIG. 3 and FIG. 4, the fixed shower head 10 includes a fixed portion 12, a first outlet portion 14, a first peripheral portion 16, and a plurality of first connectors 18 and has a first inlet channel 122, an outlet channel 124, and a regulating valve 126. The first inlet channel 122 of the fixed portion 12 is connected to a water service pipe (not shown) on the wall, so that water provided by the water service pipe is allowed to flow into the showering appliance 100. The first inlet channel 122 communicates with the first outlet portion 14 and the outlet channel 124 which communicates with the first inlet channel 122 and the handheld showerhead 20. The regulating valve 126 is disposed between the first inlet channel 122, the first outlet portion 14, and the outlet channel 124, wherein the regulating valve 126 is adapted to be operated by a user to control water flowing through the first inlet channel 122 flows into at least one of the first outlet portion 14 and the handheld showerhead 20 and to regulate a water volume which is outputted to the first outlet portion 14 and the handheld showerhead 20.

The first peripheral portion 16 is located around the first outlet portion 14 and has a plurality of first side portion 162. In the current embodiment, a number of the plurality of first side portions 162 is four as an example. The plurality of first connectors 18 is respectively disposed on at least one of the plurality of first side portions 162 of the first peripheral portion 16. In the current embodiment, a number of the plurality of first connectors 18 is four, wherein each of the four first connectors 18 is disposed on one of the four first side portions 162. However, the number of the plurality of first side portions and the number of the plurality of first connectors are not limited by the aforementioned design, wherein the number of the plurality of first connectors could be correspondingly altered according to the number of the plurality of first side portions. Each of the plurality of first connectors 18 includes a plurality of magnetic members 182, wherein each of the plurality of magnetic members 182 is a magnet, and the plurality of magnetic members 182 of each of the plurality of first connectors 18 are disposed at one of the plurality of first side portions 162 and is arranged along a longitudinal direction of a corresponding one of the plurality of first side portions 162 (i.e. a peripheral direction of the first peripheral portion 16 of the fixed shower head 10). The peripheral direction is a direction that surrounds an axis of the first inlet channel 122.

In the current embodiment, the fixed shower head 10 includes a main body 10A and a front cover 10B, wherein the main body 10A is covered with the front cover 10B, and the four first connectors 18 are respectively disposed on four side walls of the main body 10A and are covered with the front cover 10B. In another embodiment, the fixed shower head could be integrally formed as a monolithic unit, wherein each of the plurality of first connectors is correspondingly disposed on one of the first side portions during a forming process.

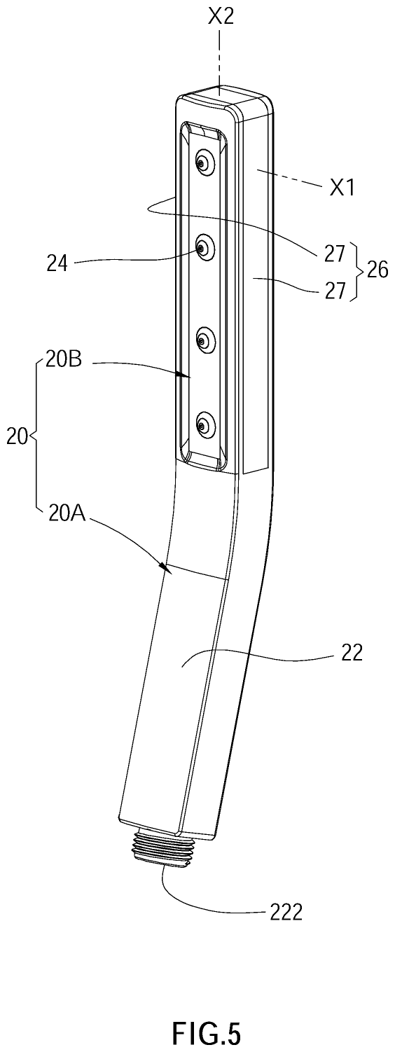

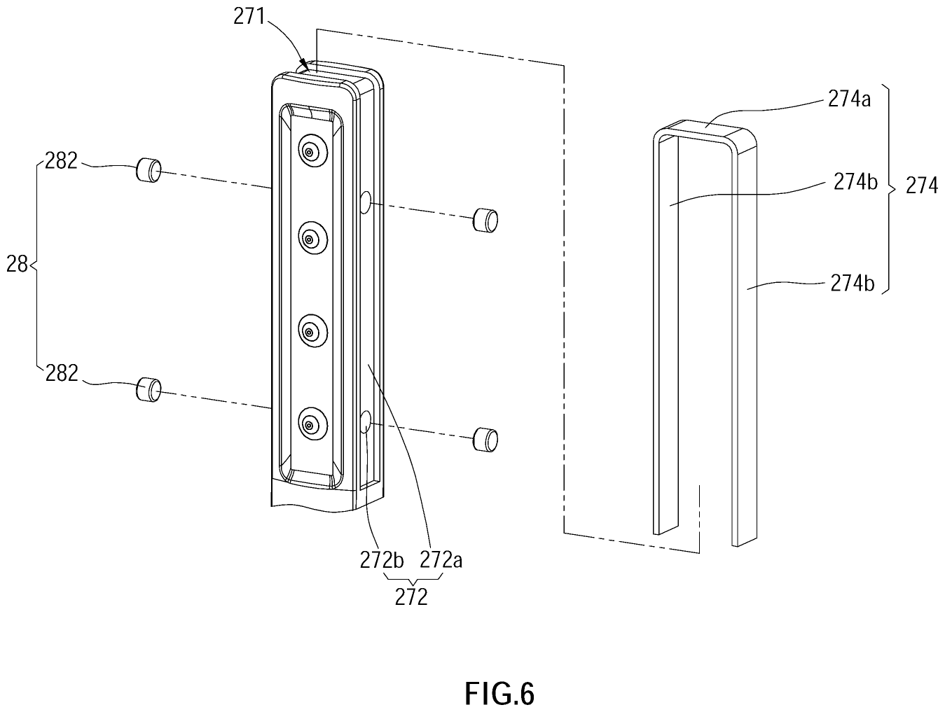

As illustrated in FIG. 5 and FIG. 6, the handheld showerhead 20 includes a handle 22, a second outlet portion 24, a second peripheral portion 26, and a plurality of second connectors 28. Additionally, in the current embodiment, the handheld showerhead 20 is long shaped and includes a first section 20A and a second section 20B, wherein the first section 20A has the handle 22, and the second section 20B has the second outlet portion 24 and the second peripheral portion 26. An obtuse angle is formed between the first section 20A and the second section 20B. A first axis of the second section 20B and a second axis of the second section 20B are defined and are perpendicular to each other. In the current embodiment, the first axis of the second section 20B and the second axis of the second section 20B are a latitudinal axis X1 and a longitudinal axis X2, respectively. However, the first axis of the second section 20B and the second axis of the second section 20B are not limited by the aforementioned design.

The handle 22 of the handheld showerhead 20 has a second inlet channel 222 which extends to the second section 20B of the handheld showerhead 20, wherein the second inlet channel 222 communicates with the second outlet portion 24. The second inlet channel 222 communicates with the outlet channel 124 of the fixed shower head 10 via a tube 30 (as illustrated in FIG. 2). The second peripheral portion 26 is located around the second outlet portion 24, and each of two opposite sides of the second peripheral portion 26 in the latitudinal axis X1 of the second section 20B has one of two second side portions 27.

As illustrated in FIG. 6, a groove 271 is recessed into a top of the second section 20B and a groove 272 is recessed into each of two sides of the second section 20B, wherein the groove 271 on the top of the second section 20B communicates with the grooves 272 on the two sides of the second section 20B. The second section 20B is disposed with a sealing member 274 including a top cover 274a and two side covers 274b which are connected to two sides of the top cover 274a. The top cover 274a seals the groove 271 on the top of the second section 20B, and the two side covers 274b respectively seals the grooves 272 on the two sides of the second section 20B. The grooves 272 on the two sides of the second section 20B and the two side covers 274b of the sealing member 274 constitutes the two second side portions 27 of the current embodiment. The grooves 272 includes a groove section 272a and at least one recess 272b, wherein the at least one recess 272b is recessed into a groove surface of the groove section 272a. In the current embodiment, a number of the plurality of second connectors 28 is two, wherein the two second connectors 28 are respectively disposed in the two grooves 272 of the two second side portions 27. However, the number of the plurality of second side portions 27 and the number of the plurality of second connectors 28 are not limited by the aforementioned design, wherein the number of the second connectors 28 could be correspondingly changed according to the number of the second side portions 27. In another embodiment, the number of the second side portion could be one, and the number of the second connector is also one, wherein the second connector is engaged in the groove of the second side portion.

Each of the second connectors 28 includes at least one magnetizable member 282 disposed in the at least one recess 272b for positioning the at least one of magnetizable member 282. In the current embodiment, the at least one of magnetizable member 282 includes a plurality of the magnetizable member 282, wherein each of the magnetizable member 282 is a magnet or a magnetizable material including iron, cobalt, nickel, or the combination thereof. A number of the recess 272b could be plural, wherein the plurality of recesses 272b are arranged along the longitudinal axis X2 of the second section 20B of the handheld showerhead 20 and corresponds to a position of the plurality of magnetic members 182 of one of the first connectors 18. Each of the plurality of magnetizable members 282 of each of the second connectors 28 is correspondingly disposed in one of the plurality of recesses 272b of one of the second side portions 27.

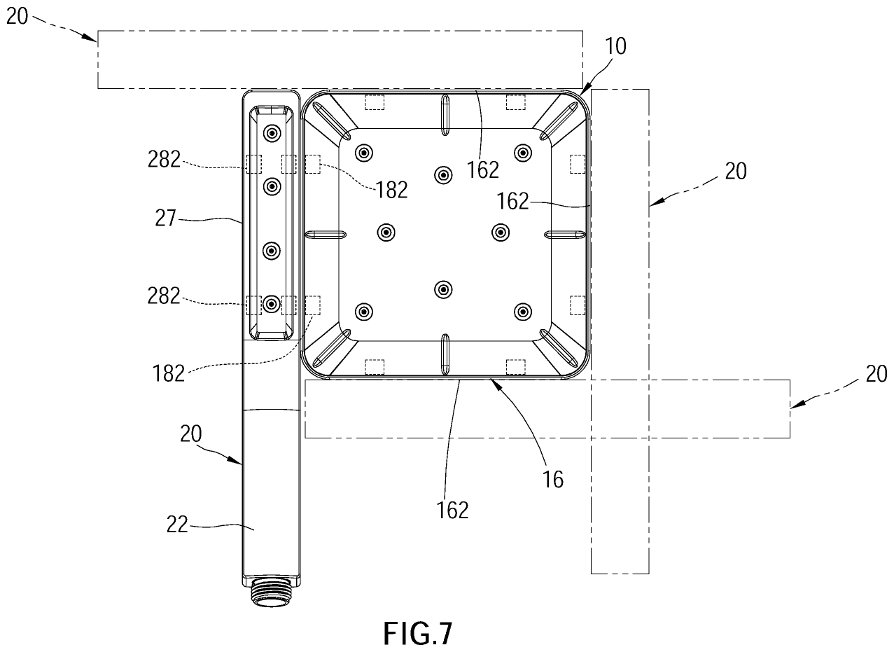

As illustrated in FIG. 7, with a magnetic attraction between the first connectors 18 and the second connectors 28, each of the second side portions 27 of the second peripheral portion 26 of the handheld showerhead 20 could selectively be attached to one of the first side portions 162 of the first peripheral portion 16 of the fixed shower head 10. For example, in FIG. 7, the plurality of magnetizable members 282 of each of the second connectors 28 of the handheld showerhead 20 are correspondingly and magnetically attached to the plurality of magnetic members 182 of the left first connector 18 of the fixed shower head 10, so that one of the second side portions 27 of the handheld showerhead 20 is magnetically attached to one of the first side portions 162 of the fixed shower head 10.

To sum up, a connection between the handheld showerhead 20 and the fixed shower head 10 is a magnetic attachment, so that the handheld shower head 20 could be moved to another positions relative to the fixed shower head 10 at will. The anther positions are illustrated by imaginary lines shown in FIG. 7. With such design, the user could use the showering appliance 100 in more various ways and could easily attach the handheld showerhead 20 to the fixed shower head 10 to expand a spray area of the fixed shower head 10. In practice, one of the first connector and the second connector includes a magnet, and the other one of the first connector and the second connector includes a magnetizable material, which could achieve an effect of magnetic attraction.

Moreover, since the handle 22 of the handheld showerhead 20 does not contact with the first peripheral portion 16 of the fixed shower head 10, so that the user could easily and conveniently hold the handle 22 and use an upper end of the handle 22 as a fulcrum to pull the handle 22 to take off the handheld showerhead 20 from the fixed shower head 10. With such design, the primary objective that the handheld showerhead is connected to the fixed shower head to form as one output is achieved, and multiple positions of the fixed shower head for attaching the handheld showerhead is provided to the user, so that various kinds of output patterns could be formed, thereby enhancing convenience.

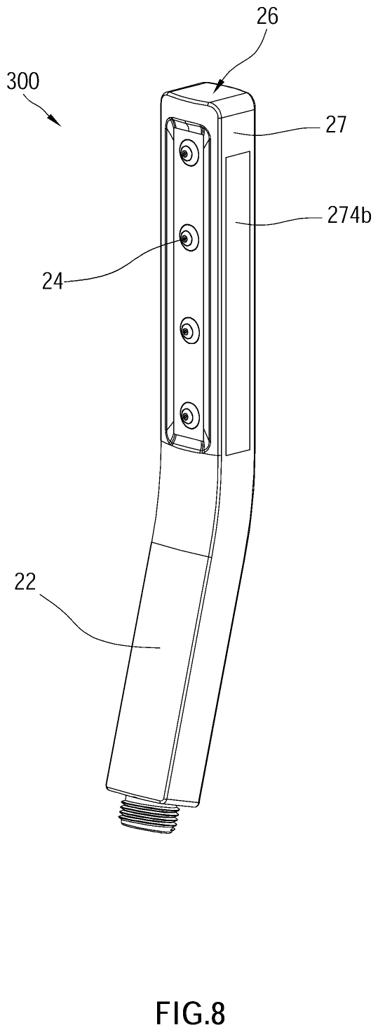

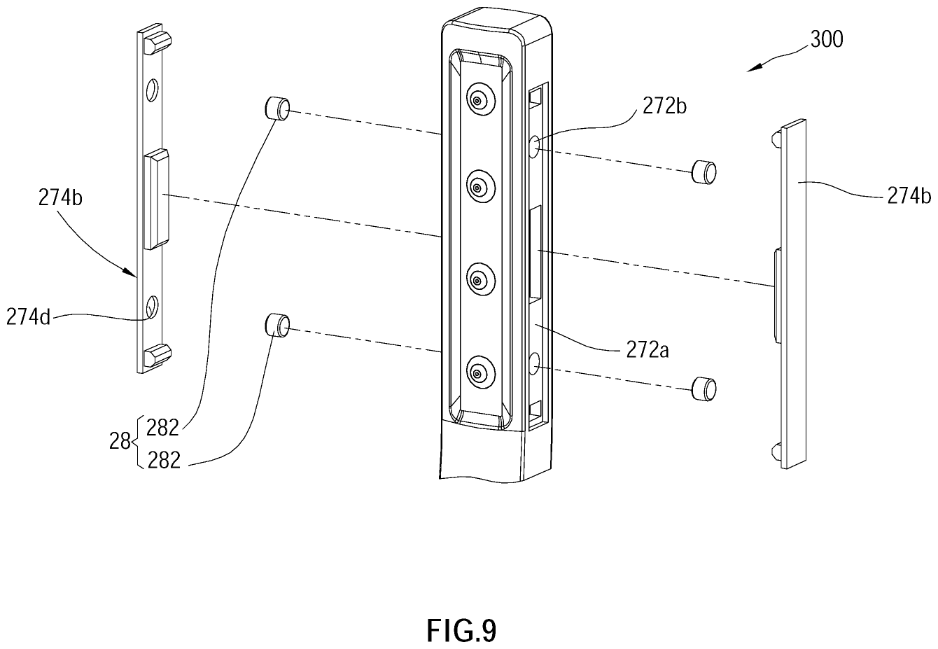

As illustrated in FIG. 8 and FIG. 9, a handheld showerhead 300 of a second embodiment according to the present invention has almost the same structure as the handheld showerhead 100 of the first embodiment, except that the two grooves 272 of the second side portions 27 do not communicate with each other at a top edge of the two grooves 272, and each of the two side covers 274b corresponding to one of the two grooves 272 is an individual component, but not formed as one sealing member. Each of the side covers 274b is engaged with a groove section 272a of one of the grooves 272. Each of the side covers 274b has an inner surface, and each of the inner surfaces faces a groove section surface of corresponding one of the groove section 272a. Each of the inner surfaces is recessed to form a plurality of recesses 274d, wherein each of the magnetizable members 282 is located in one of the recesses 272b of the grooves 272, and a part of each of the magnetizable members 282 protrudes out of one of the recesses 272b.

When each of the two side covers 274b seals an opening of one of the two grooves 272, a part of the magnetizable members 282 in the two grooves 272 is inserted into a corresponding one of the recesses 274d of one of the side covers 274b, so that the magnetizable members 282 could get closer to outer surfaces of the two side covers 274b to shorten a distance between the magnetizable members 282 of the second connectors 28 and the magnetic members 182 of the first connectors 18, thereby enhancing a magnetic force.

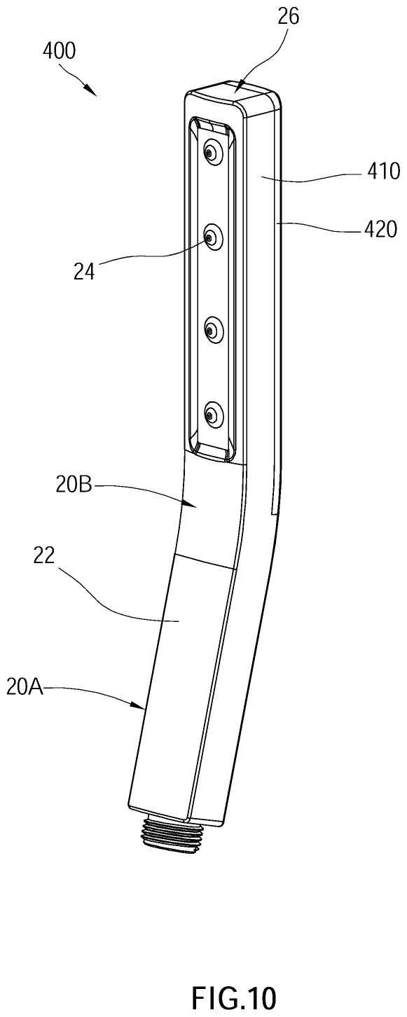

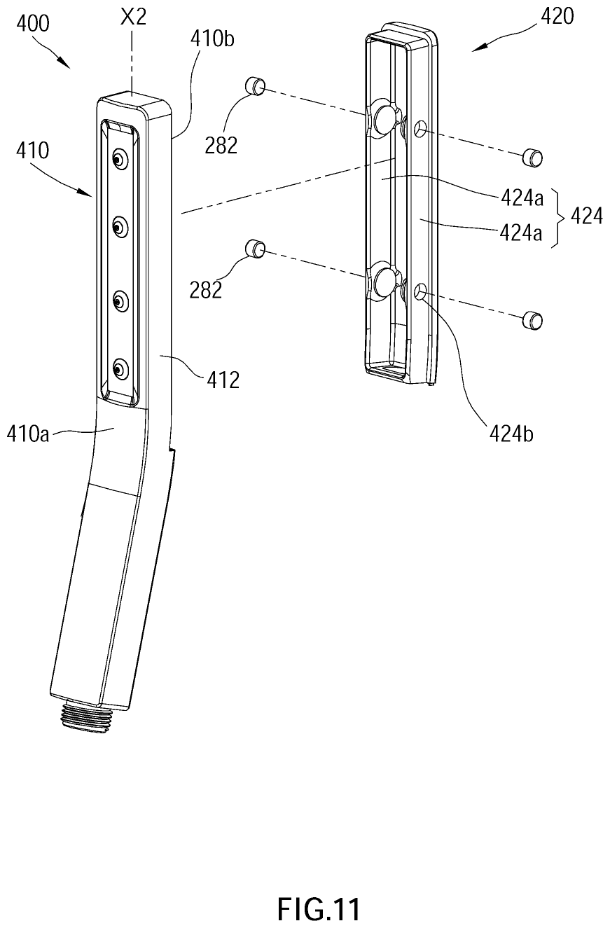

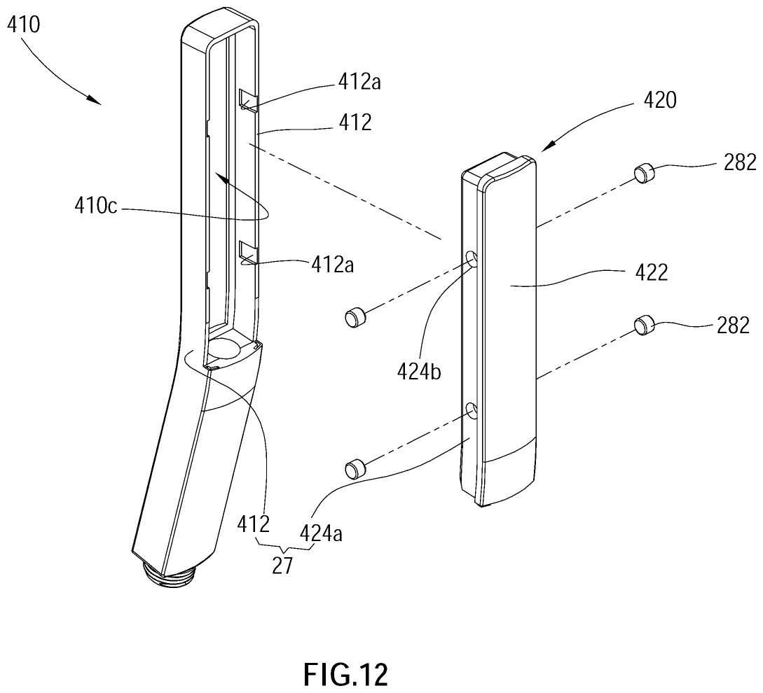

A handheld showerhead 400 of a third embodiment according to the present invention is illustrated in FIG. 10 to FIG. 12, wherein the second section 20B of the handheld showerhead 400 includes a front shell 410 and a rear cover 420. In the current embodiment, the front shell 410 of the second section 20B and the handle 22 are integrally formed as a monolithic unit. The front shell 410 has two side walls 412 which are opposite along the latitudinal axis X1 of the handheld showerhead 400 and includes a front side 410a and a rear side 410b. An inner wall of each of the side walls 412 has a plurality of slot 412a which is arranged along the longitudinal axis X2 of the second section 20B of the handheld showerhead 400. The second outlet portion 24 is located at the front side 410a of the front shell 410, and the rear side 410b of the front shell 410 has a rear opening 410c which is back to the second outlet portion 24.

The rear cover 420 includes a cover body 422 and a protruding periphery 424. The protruding periphery 424 has two side portions 424a which are opposite along the latitudinal axis X1 of the handheld showerhead 400. Each of the side portions 424a has a plurality of the recesses 424b which is arranged along the longitudinal axis X2 of the second section 20B of the handheld showerhead 400. The plurality of the magnetizable members 282 are respectively plugged into the recesses 424b of the side portions 424a of the protruding periphery 424, wherein a part of the magnetizable members 282 protrudes out of the recesses 424b of the protruding periphery 424. When the cover body 422 of the rear cover 420 seals the rear opening 410c of the front shell 410, the two side portions 424a of the protruding periphery 424 are located between the two side walls 412 of the front shell 410. The second side portion 27 is constituted of each of the side walls 412 of the front shell 410 and one of the side portions 424a of the protruding periphery 424. A part of the magnetizable members 282 of each of the second connectors 28 protrudes into corresponding one of the slot 412a of the side wall 412 of the front shell 410, so that the distance between the magnetizable members 282 of the second connectors 28 and the magnetic members 182 of the first connectors 18 is shortened, thereby enhancing a magnetic force.

The showering appliance according to the present invention allows the handheld showerhead to be magnetically attached to the fixed shower head. Even walls of a showering room are without any fixing seat, the handheld showerhead still could be fixed. When the handheld showerhead is magnetically attached to the fixed shower head, and both of the handheld showerhead and the fixed shower head are outputted at the same time, the spray area could be expanded. Additionally, the handheld showerhead could be attached to different first side portions of the fixed shower head to form various output patterns.

It must be pointed out that the embodiments described above are only preferred embodiments of the present invention. All equivalent structures which employ the concepts disclosed in this specification and the appended claims should fall within the scope of the present invention.

What is claimed is:

1. A showering appliance, comprising:
a fixed shower head comprising a fixed portion, a first outlet portion, a first peripheral portion, and a plurality of first connectors, wherein the fixed portion has a first inlet channel which communicates with the first outlet portion; the first peripheral portion is located around the first outlet portion and has a plurality of first side portions; the plurality of first connectors are respectively disposed at the plurality of first side portions; and
a handheld showerhead comprising a handle, a second outlet portion, a second peripheral portion, and a plurality of second connectors, wherein the handle has a second inlet channel which communicates with the second outlet portion; the second peripheral portion is located around the second outlet portion and has a plurality of second side portions; the plurality of second connectors are respectively disposed at the plurality of second side portions;
wherein one of the plurality of first connectors and one of the plurality of second connectors are magnetically attracted to each other, so that one of the plurality of second side portions of the second peripheral portion of the handheld showerhead is able to be magnetically attached to one of the plurality of first side portions of the first peripheral portion of the fixed shower head.

2. The showering appliance of claim 1, wherein the handheld showerhead has a first axis and a second axis which is perpendicular to the first axis; each of two opposite sides of the second peripheral portion along the first axis has one of the second side portions.

3. The showering appliance of claim 1, wherein a number of the plurality of first side portions of the first peripheral portion is four.

4. The showering appliance of claim 2, wherein each of the plurality of first connectors comprises a plurality of magnetic members which are disposed at one of the plurality of first side portions and are arranged along a peripheral direction of the fixed shower head; each of the plurality of second connectors comprises a plurality of magnetizable members, each of the plurality of magnetizable members is a magnet or a magnetizable material; the plurality of magnetizable members of each of the plurality of second connectors are disposed at one of the plurality of second side portions and are arranged along the second axis of the handheld showerhead; each of the plurality of magnetic members of one of the plurality of first connectors of the fixed shower head is magnetically attracted to each of the plurality of magnetizable members of one of the plurality of second connectors of the handheld showerhead.

5. The showering appliance of claim 1, wherein when one of the plurality of second side portions of the second peripheral portion is magnetically attached to one of the plurality of first side portions of the first peripheral portion, the handle does not contact with the first side portions.

6. The showering appliance of claim 2, wherein each of the plurality of second side portions has a groove, and each of the plurality of second connectors is disposed of in the groove of one of the plurality of second side portions; a side cover is disposed on each of the grooves to seal an opening of each of the grooves.

7. The showering appliance of claim 6, wherein each of the grooves comprises a groove section and at least one recess, and each of the groove sections has a groove surface which is recessed to form the at least one recess; each of the plurality of second connectors is disposed in the at least one recess of one of the grooves; each of the side covers is engaged with one of the groove sections; each of the side covers has an inner surface which is recessed to form at least one recess; a part of the second connectors protrudes into the at least one recess of the side covers.

8. The showering appliance of claim 7, wherein a number of the at least one recess of each of the grooves is plural; the plurality of the recess of each of the grooves is arranged along the second axis of the handheld showerhead; each of the plurality of second connectors comprises a plurality of magnetizable members which are respectively disposed in the plurality of recess of each of the grooves.

9. The showering appliance of claim 2, wherein the handheld shower head comprises a first section and a second section; the first section has the handle, and the second section comprises a front shell and a rear cover; the front shell is connected to the first section and has two side walls which are opposite along the first axis of the handheld shower head; a front side of the front shell has the second outlet portion; a rear side of the front shell has a rear opening which is opposite to the second outlet portion; the rear cover comprises a cover body and a protruding periphery; the protruding periphery has two side portions which are opposite along the first axis of the handheld shower head; the plurality of second connectors are respectively disposed at the two side portions of the protruding periphery; the cover body seals the rear opening, and the two side portions of the rear cover are respectively located between the two side walls of the front shell; each of the side walls of the front shell and corresponding one of the side portions the back cover constitute one of the plurality of second side portions.

10. The showering appliance of claim 9, wherein an inner wall of each of the side walls is recessed to form at least one recess, and a part of each of the plurality second connectors protrudes into the at least one recess on the inner wall of one of the side walls.
